(19) United States
(12) Patent Application Publication
(10) Pub. No.: US 2009/0142449 A1
(43) Pub. Date: Jun. 4, 2009

(54) Tofu production method

(76) Inventor: Fenjin He, Philadelphia, PA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/987,798

(22) Filed: Dec. 4, 2007

(51) Int. Cl. A23L 1/20

(52) U.S. Cl. 426/46

(57) ABSTRACT

The tofu production method is a process for producing tofu that uses transglutaminase enzyme to improve the texture and elasticity of the tofu, so that soft or silken tofu is more resistant to mechanical abuse during food preparation, and firm tofu can be sliced. The amount of transglutaminase is less than 0.001 parts by weight, or less than 2 units per gram. According to one process, the coagulant and the transglutaminase are added to cold soymilk, placed into a tofu tray and sealed, heat-treated at 50° C. for 0.5-1 hour, then at 85° C. for 40-70 minutes to produce silken tofu. According to another process, the coagulant is added to the soymilk and the mixture is coagulated to form curds at 85° C., the whey is drained from the curds, the curds are cooled to 50° C., the transglutaminase is added, and the curds are placed into a pressing mold to make firm tofu.

### BACKGROUND OF THE INVENTION

1. Field of the Invention

The present invention relates to methods for processing vegetable protein, and particularly to a tofu production method that may be used to produce soft, silken tofu or a harder tofu that may be sliced, depending upon the process conditions.

2. Description of the Related Art

In a traditional process for producing tofu, tofu is produced by adding a coagulant to soybean milk and pressing the curds produced by coagulation into blocks. Commercially, the coagulant used may be a salt, such as calcium sulfate or a chloride-type nigari salt, or an acid, such as glucono delta-lactone. Nigari is a powder originally believed to be produced in Japan from seawater by removal of sodium chloride and evaporation of water, and primarily contains magnesium chloride, but may also contain small amounts of magnesium sulfate, calcium chloride, and other naturally occurring salts. Food-grade magnesium chloride synthesized in the laboratory has also been used as a coagulant for producing tofu. Tofu made with nigari is considered to have a smoother, tender texture.

The consistency of tofu can vary, depending upon the amount of water that is removed from the curds. At one extreme, soft or silken tofu has the highest moisture content, and has the consistency of custard. At the other extreme, firm or dried tofu has the smallest moisture content, and has the firmness of cooked meat. A problem with conventional tofu is that soft or silken tofu is easily breakable using normal cooking methods or stirring with a spatula, while firm tofu is often brittle and will crumble when sliced.

Recently many studies have been performed that suggest that the texture of tofu may be improved by the addition of transglutaminase enzyme. Transglutaminase is a generic term describing related naturally occurring enzymes that are thought to play a role in catalyzing the formation of covalent bonds that result in crosslinking proteins and peptides to form molecular polymers. Nevertheless, appropriate concentrations of the ingredients and appropriate processing conditions for forming a more elastic soft tofu or a less brittle firm tofu have not been found.

Thus, a tofu production method solving the aforementioned problems is desired.

### SUMMARY OF THE INVENTION

The tofu production method is a process for producing tofu that uses transglutaminase enzyme to improve the texture and elasticity of the tofu, so that soft or silken tofu is more resistant to mechanical abuse during food preparation, and firm tofu can be sliced. The amount of transglutaminase is less than 0.001 parts by weight, or less than 2 units per gram. According to one process, the coagulant and the transglutaminase are added to cold soymilk, placed into a tofu tray and sealed, heat-treated at 50° C. for 0.5-1 hour, then at 85° C. for 40-70 minutes to produce silken tofu. According to another process, the coagulant is added to the soymilk and the mixture is coagulated to form curds at 85° C., the whey is drained from the curds, the curds are cooled to 50° C., the transglutaminase and flavoring agents are added, and the curds are placed into a pressing mold to make firm tofu.

These and other features of the present invention will become readily apparent upon further review of the following specification.

### DETAILED DESCRIPTION OF THE PREFERRED EMBODIMENT

The present invention relates to a tofu production method that is a process for producing tofu using transglutaminase enzyme to improve the texture and elasticity of the tofu, so that soft or silken tofu is more resistant to mechanical abuse during food preparation, and firm tofu can be sliced. The amount of transglutaminase is less than 0.001 parts by weight, or less than 2 units per gram. According to one process, the coagulant and the transglutaminase are added to cold soymilk, placed into a tofu tray and sealed, heat-treated at about 50° C. for 0.5-1 hour, then at about 85° C. for 40-70 minutes to produce silken tofu. According to another process, the coagulant is added to the soymilk and the mixture is coagulated to form curds at about 85° C., the whey is drained from the curds, the curds are cooled to about 50° C., the transglutaminase and flavoring agents are added, and the curds are placed into a pressing mold to make firm tofu.

In carrying out the tofu production method, any conventionally known coagulant may be used. Nigari, which primarily contains magnesium chloride (MgCl₂), is preferred, but calcium sulfate, food-grade magnesium chloride, other chloride-type nigari salts, or glucono delta-lactone may be used to coagulate the soybean milk to form curds instead. A preferred source of transglutaminase is Activa-TI (or TG-TI), made by Ajinomoto Co. of Japan, having a transglutaminase enzyme composition of about 1% by weight.

In more detail, in the process for preparing soft or silken tofu, transglutaminase is added to cold soymilk. Coagulant, which may be calcium sulfate, magnesium chloride (nigari), or a combination of the two, is then added to the cold soymilk. The mixture is then filled into a tofu tray and sealed. The sealed tray is then subjected to heat treatment at two different temperatures: first, for about one hour at 50° C., then for about forty minutes at 85° C. The resulting silken tofu is very elastic, and not easily breakable, making it superior in texture to tofu prepared by conventional methods.

According to information provided by the Ajinomoto Co. of Japan, the optimal temperature for using transglutaminase is about 50° C. At higher temperatures, the enzyme tends to degrade and loses the capacity to crosslink proteins and peptides to polymerize the soymilk proteins into long chain polymers. The first period of heat treatment at about 50° C. allows sufficient time for long chain polymers to form. The second period of heat treatment at 85° C. quenches the polymerization reaction and stabilizes the tofu, so that the tofu has a soft, silken texture upon cooling with enough elasticity to maintain mechanical integrity during cooking or food preparation procedures.

An alternative method of preparation of soft or silken tofu is to mix transglutaminase with cold soymilk and refrigerate the mixture, e.g., overnight or about 12 hours. Then the coagulant (calcium sulfate, magnesium chloride (nigari), or a combination of the two) is added to the mixture. The mixture is placed into a tofu tray, sealed, and subjected to heat treatment at about 85° C. for about 90 minutes. This procedure does not require heat treatment at 50° C., since overnight storage while refrigerated allows enough time for sufficient crosslinking to occur to impart elasticity to the soft tofu.

Applicant has performed various experiments to optimize the concentration of transglutaminase and the temperature ranges and duration of heat treatment for acceptable soft tofu texture. The following examples exemplify the tofu production method for preparing soft or silken tofu according to the present invention.

### EXAMPLE 1

As summarized in Table I below, a quantity of Ajinomoto Activa-TI (1% transglutaminase content by weight) was added to six liters cold soymilk (13.5 Brix at 4° C.), and a fixed volume of nigari (magnesium chloride) coagulant was added to each sample. The samples were placed in tofu trays, sealed, and subjected to heat treatment at 131° F. (55° C.) for about 30 minutes, followed by heat treatment at 185° F. (85° C.) for about 70 minutes. The qualitative results for texture corresponding to different quantities of transglutaminase are summarized in Table I, wherein the weight percentage of transglutaminase is computed by:

$$\frac{weight of Activa ( g ) \times 1 \% wt enzyme / wt Activa}{6000 g soymilk} \times 100 \% = wt \% enzyme$$

TABLE I
Effect of enzyme concentration

| Sample | Milk | Activa | MgCl₂ | | Texture |
|---|---|---|---|---|---|
| No. | (L) | (g) | (19 Brix) | % Enz. | Results |
| A | 6 | 2 | 50 ml | 0.000333 | very good |
| B | 6 | 4 | 50 ml | 0.000667 | very good |
| C | 6 | 6 | 50 ml | 0.001 | too elastic |
| D | 6 | 8 | 50 ml | 0.00133 | too elastic |

Even at the lowest concentration of transglutaminase, the tofu is much more elastic and springy than conventional soft or silken tofu. Sample B exhibited somewhat better. The tofu is not easy to break. One can cut a ⅛″ thick strip and wrap it around one's finger without breaking the strip. For comparison purposes, samples A through D were compared to control samples having the same composition, but without the enzyme. When the control samples are compared to slices of samples A through D having the same thickness, the control slices could not be picked up without breaking.

### EXAMPLE 2

A large batch size was tested for production purposes. The batch included 28 gallons (about 245 pounds) of soymilk, which measured 13.5 Brix at 6° C. About 65 grams of Activa-TI were mixed with 300 ml of water using a blender. The Activa was then added to the soymilk being sure to rinse the blender with a small amount of water. This resulted in a concentration of about 0.0006 wt % transglutaminase in soymilk (65 g×1%/(245 lbs×454 g/lb.)×100%). About 900 ml nigari at 19 Brix was added to coagulate the soymilk. The mixture was used to fill a 20-ounce tofu tray and sealed. The sealed tray was subjected to heat treatment at 50° C. for about 40 minutes, followed by heat treatment at about 85° C. for about one hour. The tray was then cooled to refrigerated temperature range. The texture of the resulting silken tofu was very good, with better elastic properties than those obtained in Example 1. When cut to ⅛″ strip, the tofu could be wrapped around the finger without breaking, and could be picked up without breaking when cut to a thin slice.

### EXAMPLE 3

In order to test the effect of temperature variation, a batch similar to Example 2 was prepared, but the second stage of heat treatment was at 90° C. for about one hour, instead of at 85° C. for one hour. No visual difference in texture was noted. The tofu exhibited good texture with good elasticity. It is anticipated, however, that the slightly higher temperature of the second stage of heat treatment will offer better shelf life.

### EXAMPLE 4

As an alternative to the two-stage heat treatment, a process for preparing silken tofu by premixing the enzyme with the soymilk overnight was tested. 65 g of Activa-TI were mixed with about 300 ml of cold water using a kitchen mixture. The Activa was then added to about 28 gallons of soymilk having a Brix of 13.75 at 5° C. The soymilk-enzyme composition was mixed well, covered, and left in a refrigerated room (35-40° F.) overnight (˜12 hours). About 960 ml of nigari (MgCl₂) having a Brix of 17.75 were mixed with three liters of water and added to the soymilk-enzyme mixture in order to coagulate the soymilk and mixed well. A twenty-ounce tray was filled with the mixture and sealed, then subjected to heat treatment at 85° C. for about 90 minutes. The resulting silken tofu was similar to the result of Examples 2 and 3, but perhaps slightly more brittle that with the two-stage heat treatment, although with better texture and elasticity than silken tofu prepared according to conventional methods. This procedure has the advantage of premixing the enzyme with the soymilk the night before, and saves time in the heat treatment process.

### EXAMPLE 5

The effect of premixing transglutaminase under different subsequent heat treatment processes was evaluated. Four different compositions were prepared, each composition being divided into two samples, as summarized in the following Table II.

TABLE II
Enzyme concentrations tested

| Sample | Soymilk | Activa | MgCl₂ | |
|---|---|---|---|---|
| No. | (lb) | (g) | (18 Brix) | % Enz. |
| A1/A2 | 17.6 | 5.33 | 60 ml | 0.000667 |
| B1/B2 | 17.6 | 2.66 | 60 ml | 0.000333 |
| C1/C2 | 17.6 | 1.33 | 60 ml | 0.000166 |
| D1/D2 | 17.6 | 0.67 | 60 ml | 0.000084 |

In each case, the Activa-TI was mixed with 100 ml of water and added to the cold soymilk. The mixture was left in a refrigerated room (˜5° C.) for about 20.0 hours. About 60 ml of the coagulant (MgCl₂, Brix 18) was diluted with 200 ml of cold water, and then added to the soymilk-enzyme mixture, mixing well with slow stirring to avoid creating bubbles. The resulting mixtures were placed into 20 oz. tofu packages and divided into two groups for heat treatment. Group 1, which included samples A1, B1, C1, and D1, was subjected to a single heat treatment stage at 85° C. for about 90 minutes. Group 2, which included samples A2, B2, C2, and D2, was treated at 50° C. for about 30 minutes, followed by treatment at 85° C. for about 70 minutes.

Sample A1 resulted in very good texture. A thin slice (˜⅛″ thick) could be hung on a finger without breaking. Sample B1 also resulted in good texture, so that a thin slice could be hung on a finger without breaking. Sample C1 did not result in very good texture. A thin slice could not be hung on a finger without breaking. Sample D1 resulted in worse texture than sample C1. Samples A2, B2, C2, and D2 all resulted in very good texture. Even sample D2, having the lowest concentration of enzyme, showed significant improvement in texture so that a thin slice could be hung on a finger without breaking.

The results in Example 5 might make production easier during the pasteurization (heating) step, since only a single temperature would be required. The drawback would be that a storage tank for holding the soybean milk-enzyme mixture would be required for an extended period of time. At a 20-hour holding time in the one-step process, even 0.000333% enzyme concentration worked well. It is anticipated that a slight increase in enzyme concentration or a slight increase in the holding temperature (e.g., 6° C. to 8° C.) might shorten the holding time to better suit production practice. On the other hand, the two-stage heat treatment (50° C./30 minutes, 85° C./70 minutes) and 20-hour holding time worked well with an enzyme concentration as low as 0.000084%, with potential resulting cost savings.

Applicant has performed various additional experiments to optimize the concentration of transglutaminase and the temperature ranges and duration of heat treatment for acceptable firm tofu texture. The following examples exemplify the tofu production method for preparing firm tofu according to the present invention.

### EXAMPLE 6

Soymilk was coagulated with calcium sulfate at 85° C. The curd was broken into smaller pieces and the whey was drained from the curd to produce 30 pounds of curd. The curd was cooled to between 50-55° C. and 10 grams of Activa (1% transglutaminase enzyme by weight) and vegetarian chicken flavor (about 200 g) were added to the curds. The resulting mixture was placed into a tofu mold lined with cheesecloth and pressed for two hours. The result was a 15-pound block of firm tofu with a transglutaminase content calculated as follows:

% enz.=[(10 g×1% enz./g of Activa)/(30 lbs×454 g/lb)]×100%=0.000734% enz.

The 15-pound block was cut into three blocks measuring approximately 115×75×250 mm each, placed into a thin plastic bag, and cooled overnight in a cold water bath. The tofu blocks were sliced into slices ˜2 mm thick, vacuum packed, and pasteurized. The resulting slices were mechanically very strong, stronger than slices made from extra firm tofu without transglutaminase.

### EXAMPLE 7

The procedure in Example 6 was repeated, but with a reduction in the vegetarian chicken flavor to 150 grams and a reduction in the enzyme to 5 grams of Activa (0.000367% enzyme by weight in the resulting tofu). The resulting firm tofu had very good texture and was mechanically strong. The tofu of Example 7 is preferable to the tofu of Example 6, since the latter was almost too strong mechanically with an undesirable rubbery texture.

### EXAMPLE 8

Spices were added to the firm tofu to create a deli block. For each thirty pounds of drained curds, 263 g of vegetarian chicken flavor, 160 g of a blend of spices, and 5.5 g of Activa (1% transglutaminase by weight) were added, the enzyme being pre-mixed with the flavoring before adding to the drained curds according to the procedure in Example 6. The resulting blocks of firm tofu sliced very nicely with good texture.

It should be understood that, in some cases, the order of the steps may be altered within the scope of the present invention. For example, in making firm tofu, it may be preferable to pasteurize the tofu after pressing and before cooling in order to achieve optimal pasteurization temperatures in the block of tofu.

It is to be understood that the present invention is not limited to the embodiments described above, but encompasses any and all embodiments within the scope of the following claims.

I claim:

1. A tofu production method for making soft tofu, comprising the steps of:
mixing less than 0.001 parts by weight transglutaminase with cold soymilk;
allowing the mixture of transglutaminase and soymilk to sit for sufficient time to permit crosslinking of the transglutaminase with protein in the soymilk;
mixing a coagulant with the mixture of transglutaminase and soymilk;
placing the mixture of transglutaminase, soymilk, and coagulant in a tofu tray;
sealing the tofu tray containing the mixture of transglutaminase, soymilk, and coagulant; and
subjecting the sealed tofu tray to heat treatment to form soft tofu.

2. The tofu production method according to claim 1, wherein:
said step of mixing coagulant and said step of mixing transglutaminase are performed simultaneously; and
said step of subjecting the sealed tofu tray to heat treatment comprises:
subjecting the sealed tofu tray to a first heat treatment at about 50° C. for about 0.5 hours to about one hour, said step of allowing the mixture of transglutaminase and soymilk to sit for sufficient time to permit crosslinking occurring during the first heat treatment step; and
thereafter, subjecting the sealed tofu tray to heat treatment at about 85° C. for about between forty minutes to seventy minutes.

3. The tofu production method according to claim 1, wherein:
said step of allowing the mixture of transglutaminase and soymilk to sit for sufficient time to permit crosslinking comprises allowing the mixture of transglutaminase and soymilk to sit for about twelve hours at a temperature of between about 35° F. to about 40° F., said step of adding the coagulant being performed after said step of allowing the mixture of transglutaminase and soymilk to sit for sufficient time to permit crosslinking; and
said step of subjecting the sealed tofu tray to heat treatment consists of subjecting the sealed tofu tray to a single heat treatment stage at about 85° C. for about 90 minutes.

4. The tofu production method according to claim 1, wherein said coagulant comprises at least one coagulant selected from the group consisting of a calcium salt, a magnesium salt, and glucono delta-lactone.

5. The tofu production method according to claim 1, wherein said coagulant is selected from the group consisting of a calcium sulfate and magnesium chloride.

6. A tofu production method for making firm tofu, comprising the steps of:
heating soymilk to about 85° C.;
adding a coagulant to the heated soymilk to form curds;
draining whey from the curds;
cooling the curds to about 50° C;
mixing less than 0.001 parts by weight transglutaminase with the curds;
placing the mixture of transglutaminase and curds into a tofu mold; and
pressing the mixture of transglutaminase and curds in the tofu mold to form a block of firm tofu.

7. The tofu production method according to claim 6, further comprising the step of mixing flavoring agents with the curds when mixing the transglutaminase with the curds.

8. The tofu production method according to claim 6, further comprising the step of pasteurizing the block of firm tofu.

9. The tofu production method of claim 6, further comprising the steps of pasteurizing the block of firm tofu, slicing the tofu, and packaging the slices.

10. The tofu production method according to claim 6, further comprising the step of cooling the firm tofu in a cold water bath.

11. The tofu production method according to claim 10, further comprising the step of pasteurizing the block of firm tofu prior to the step of cooling the firm tofu.

12. The tofu production method according to claim 6, further comprising the step of breaking the curds before the step of draining the whey from the curds.

13. Tofu containing less than 0.001 parts transglutaminase to protein by weight.
